(19) United States
(12) Patent Application Publication
(10) Pub. No.: US 2003/0172730 A1
(43) Pub. Date: Sep. 18, 2003

(54) Fluid flow sensor assembly

(76) Inventor: Douglas Clint Reed, North Wilkesboro, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/354,880

(22) Filed: Jan. 30, 2003

Related U.S. Application Data
(60) Provisional application No. 60/352,955, filed on Jan. 30, 2002.

(51) Int. Cl. G01F 7/00

(52) U.S. Cl. 73/195

(57) ABSTRACT

An apparatus comprising: a base plate and a cover plate, said plates spaced apart by a pair of transfer blocks being mounted and held between the base plate and the cover plate, mounted between the transfer blocks is one or more fluid flow sensor switches, for measuring the presence of liquid flowing there through. The invention can serve as a substantially automatic means of assuring that there is always fluid available for an applicator, such as a wet blade, as the fluid flow sensors are demand driven. If the fluid runs low, the back pressure on the output side of the fluid line drops, and delta pressure across the fluid sensor increases, causing the fluid sensor to open and fluid to flow. An electrical switch, such as a reed switch, signals the controller that fluid is flowing.

### CROSS REFERENCE TO RELATED APPLICATIONS

This application claims benefit under 35 U.S.C. section 119 of provisional application 60/352955 filed Jan. 30, 2002. The disclosure of this application is incorporated by reference herein in its entirety.

### BACKGROUND OF THE INVENTION

1) (Field of the Invention)

The present invention relates to an assembly capable of detecting the flow of fluid through multiple lines. In particular, the assembly maybe used with any multiple flow lines for detecting the presence of fluid flow through any given line in a given time frame. A fluid flow sensor sends a signal to the computer, for example, or other type display to indicate the presence of fluid flowing through the line in a given time frame. More specifically, the present invention is capable of monitoring the flow of chemicals being applied to grass, weeds, or brush being cut by a mower, such chemicals being fertilizer, weed killer, insecticide, anti-mold and mildew compounds, or other chemicals in a liquid medium.

2) (Prior Art)

The present invention is designed to be particularly applicable to the Burch Wet Blade Mower. Patents relating to the wet blade mower U.S. Pat. Nos. 6,125,621, and 6,164,049. Specifically, this mower deck cuts weeds, brush, or grass, for example, and applies a liquid chemical treatment to the brush, grass, or weeds. The details of the specific application of the Burch Wet Blade Mower are discussed in the above identified patents, and the present device, while specifically intended for use on the Burch Wet Blade, can find uses in any application where the presence of fluid being applied or flowing through a line must be known.

### SUMMARY OF THE INVENTION

The present invention is adopted to be positioned between a supply of fluids (chemicals), which are typically being applied to grass, weeds, or brush by the Burch Wet Blade™ Mower. The present invention measures the amount of fluid being applied in a given period of time. For example, if the manufacturer of the chemicals indicate that they should be applied at one gallon per one hundred square feet, it is necessary to know the amount of fluid flowing through a line and to control that amount of fluid. The present invention is simply an apparatus which determines the presence of fluid flowing through a line, and signals a controlling device, such as a computer, relative to whether fluid is flowing through one or more lines. Under normal operating conditions the rate of flow is known.

In the broadest sense, the present invention comprises: 1) inserting a general fluid flow between the source of the liquid and the applicator of the liquid; 2) determing the presence of fluid flowing through the line, and 3) sending an electrical signal to a control device, and repeating steps 2 and 3 during operation.

The invention can serve as a substantially automatic means of assuring that there is always fluid available for an applicator, such as a wet blade, as the fluid flow sensors are demand driven. If the fluid runs low, the back pressure on the output side of the fluid line drops, and delta pressure across the fluid sensor increases, causing the fluid sensor to open and fluid to flow. An electrical switch, such as a reed switch, signals the controller that fluid is flowing.

### OBJECTS OF THE INVENTION

A first object of the invention is to provide a fluid flow assembly, wherein the assembly can be quickly mounted and connected to the input and output fluid lines. The fluid flow assembly can be pre-assembled so that rapid installation is possible with only a few tools.

A second object of the invention is to provide a fluid flow assembly, wherein the assembly provides a protective case for one or more fluid flow sensors.

A third object of the invention is to provide a fluid flow assembly, wherein the fluid flow sensors produce an electrical response to fluid flow through the sensor.

A fourth object of the invention is to provide a fluid flow assembly, wherein the fluid flow sensors that are within a protective case can be easily inspected in the field, wherein the case has a quick removal cover.

A fifth object of the invention is to provide a fluid flow assembly having a means for fitting multiple fluid flow sensors to transfer blocks having fittings for easy coupling to fluid lines.

A sixth object of the invention is to provide a fluid flow assembly having a substantially automatic means of assuring that there is always fluid.

### BRIEF DESCRIPTION OF THE DRAWINGS

FIG. 1 is a partially exploded perspective view of the invention with the cover removed.

FIG. 2 is an exploded view of the fluid flow sensor assembly.

FIG. 3 is a perspective view of the invention

FIG. 4 is a top view of the invention.

FIG. 5 is a plan view of the invention.

FIG. 6 is a side view of the invention.

FIG. 7 is a partially cutaway view of a fluid flow sensor switch.

### DESCRIPTION OF THE PREFERRED EMBODIMENTS

The materials for making the assembly are primarily metals except for the fluid flow lines, which may be plastic or metal. The metal employed can be brass, copper, aluminum, iron plating, steel, or specialty metals such as stainless steel. Preferably, the present invention uses brass for all the fittings and iron plating for the covers assemblies.

In the Figures shown there is a perspective view of the invention with the cover removed, an exploded view, an assembled perspective view, a top view, a plan view, a side view, and a partially cutaway view of a fluid flow sensor switch for a total of 7 Figures. As shown in the Figures there are three fluids flow lines although more or less maybe employed depending on what chemicals need to be applied.

Referring to all the Figures, the invention 10 has a based plate 12 has a cover plate 28 and the function of these two plates is to protect the fluid flow switches 18. A source of chemicals for each of the three lines shown is not a part of the present invention although the fluid line 34 from the source is. In particular, the input for the fluid line 34 is coupled to a brass male adapter 5 by any known means such as by a clamp. Although the male adapter is preferably brass, it maybe made of any metal, that does not corroded by the liquid chemical flowing through the line. Each of the male adapters 5 are threaded and designed therefore to fit within the swivel 7, which has a female portion having threads and adapted to receive the male adapter 5 in a type fluid. The swivel 7 is also solidly secured to a transfer block 14. Secured to the other side of the transfer block 14 are general fluid flow switches 18. These fluid flow switches are connected at one end to the transfer block 14 and on the other end to swivel adapter 7 as described previously.

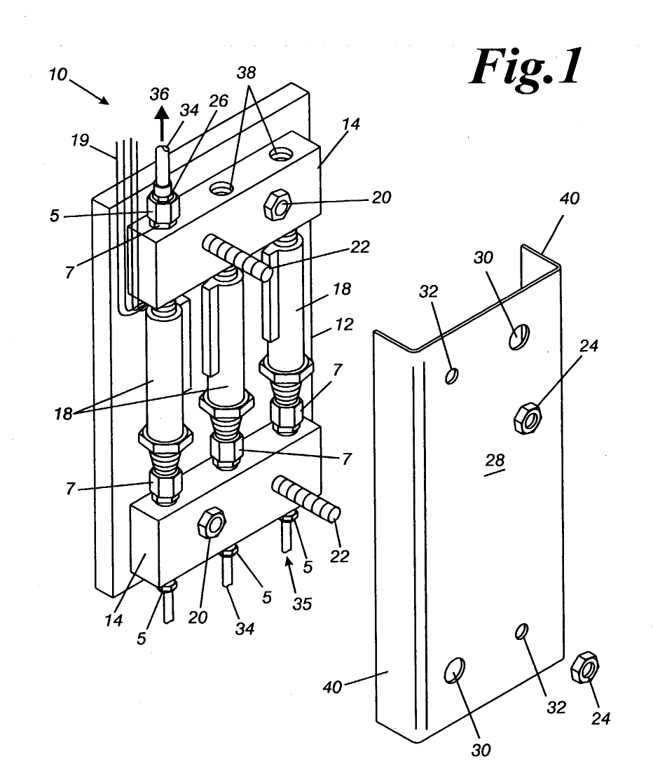

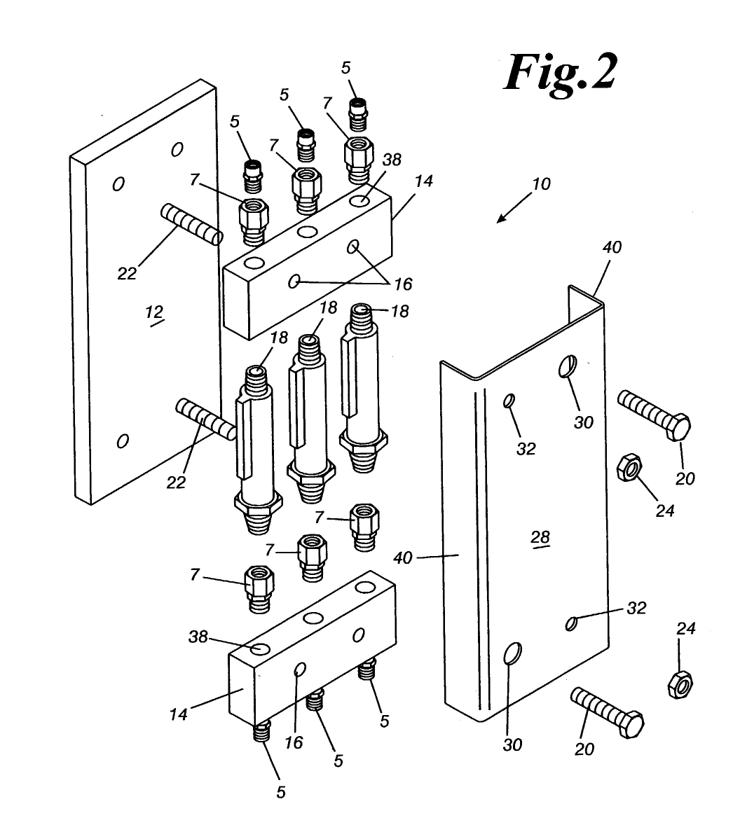

As more clearly illustrated in the exploded view, the source of the fluid has a fluid line 34 that is connected to a threaded male adapter 5, which in turn is adapted to be fluidly coupled with a swivel threaded adapter 7. In the exploded assembly this connection occurs in the upper part of the drawing. Then between the two transfer blocks 14, are the fluid flow sensor switches 18 (one for each line), where a fluid line has an input 35 and an output 36 as shown in FIG. 1. Referring to FIGS. 1 and 2, the lower end of the fluid flow sensor switches 18 have threads which are adapted to fully couple with the swivel coupling 7. The lower set of the swivel female couplers then is in a sealing relation with the lower transfer block 14, and the opposite side of the transfer block 14 likewise has a male adapter 5. The cover plate 28 has side walls 40, which enclose and protect the fluid flow sensor switches 18 from the side. A minimum number of bolts and nuts are used to mount the elements of the invention. Each of the two transfer blocks are fastened to the base 12 with a bolt 20 and a stud 22. Apertures, 30 and 32, are cut into the face of the cover plate 28 to receive the head of the bolt 20 and stud 22, respectively. The apertures, 30 and 32, enable cover to sandwich the transfer blocks 14 between the base plate 12 and the cover plate 28 as shown in FIG. 2. Each of the studs traverse from the base plate 12, through the holes 16 in the transfer block and through the face of the cover plate 28. Each stud is fitted with a fastening device, like a nut, wing nut or push nut. A nut 24 is shown in the Figures. The fluid flow switches 18 have at least a pair of terminals on each switch designed to receive electrical wiring 19 as shown in FIG. 1. The wiring is coupled to a controller, such as computer, not shown. A typical flow sensor switch 18 is shown in FIG. 7. A pipe-like chamber 48 is fitted with a piston 46 that is magnetic. The entrance and exit are typically threaded 50. The piston 46 is loaded with a spring 42 and sealed with an O-ring 44. Adjacent to the chamber is a reed switch 17, which is actuated when the piston moves. When pressure against piston is sufficient to compress the spring 42, the piston slides and the movement causes the reed switch to open (or close—depending on the configuration).

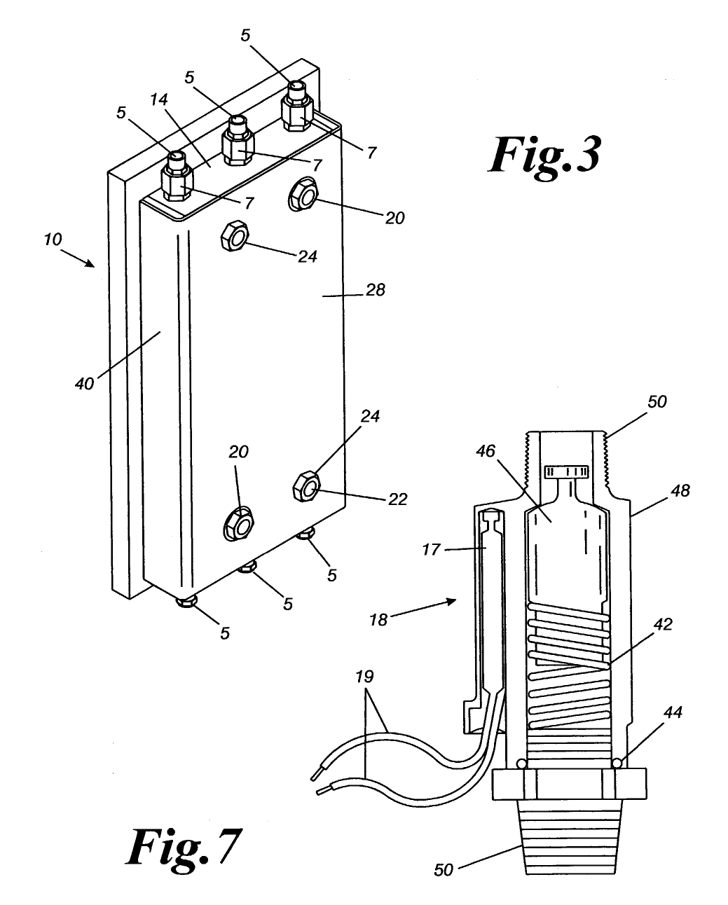

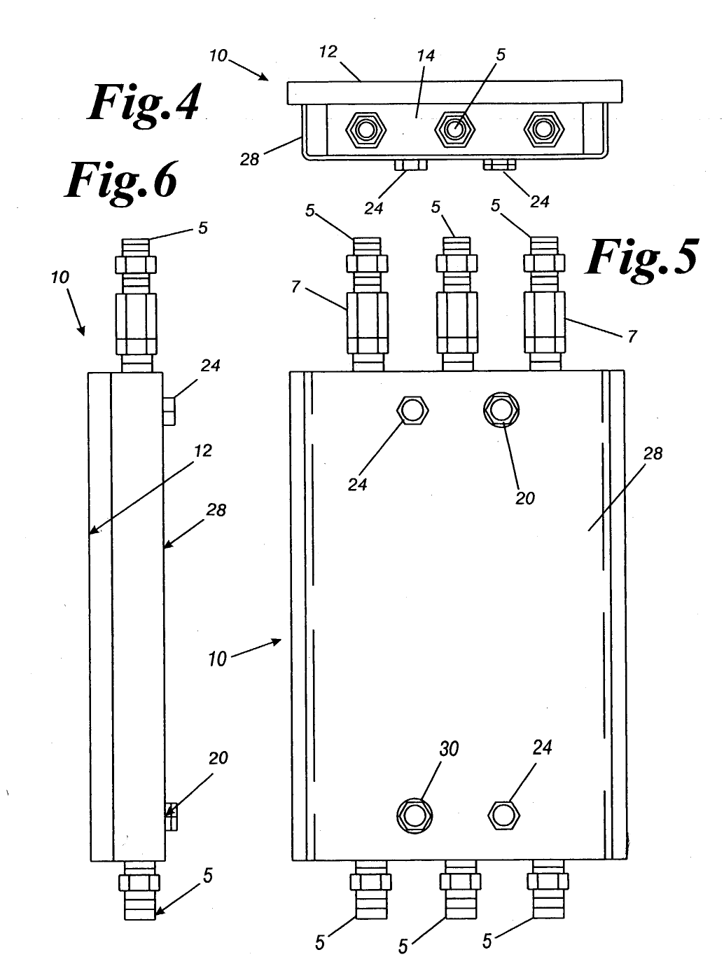

In operation, and for the purpose of explanation, the fluid flows from the lower to upper lower portion of the invention as shown in FIGS. 1, 2, 3, 5 and 6. Two transfer blocks 14 are mounted on the based plate 12 by means of bolts, studs and nuts 20, 22, and 24. The fluid line 34 from the source of chemicals inputs at 35, and is connected to the male threaded adapters 5 on the bottom of the fluid flow sensor assembly 10. The invention can be orientated in any direction, and the aforementioned bottom is merely a convenient term used to describe the elements as shown in the Figures. The male adapter in turn is connected to lower transfer block 14. Because the threaded adapter swivels, one is able to disconnect the fluid line 34 from the flow sensor assembly when desired. The threaded adapter 7 is also connected to the lower transfer block 14. Again as shown in FIGS. 1, 2, 3, 5 and 6, the fluid flow switches 18 have their upper end connected to a fluid line 34 held secure by the transfer block 14, and fluidly connected to the lower portion of the swivel threaded adapter 7. Fluid line 34 is attached to swivel 7 using fluid line adaptor 26. Not shown are the terminals for the reed switch 17, as seen in FIG. 7, for the each fluid flow switch 18. Electrical wiring (not shown) connects the terminal to the controller, such as a computer. The upper portion of each fluid flow switch, as shown in the Figures includes male threads 50 as shown in FIG. 7. These male threads are adapted to be coupled with a second transfer block 14 as shown. Again, the upper portion of the threaded female adapters are designed to securely connect to the flow switch 18, and the other side of the transfer block 14 is a threaded male end of the swivel adapter to coupler, which is design to couple the fluid flow sensor assembly to a device, such as a wet blade™, which applies the fluid. Although not shown, the upper threaded male couplers are designed to fluidly couple with a swivel coupler like those shown by reference numeral 7.

### Example 1

The base plate 12 is and aluminum plate that is ½×5×7½ inches. Each of the two transfer blocks 14 is also constructed of aluminum and is ¾×1½ 4 inches. The blocks are machined with three through-block threaded channels 38, each having a ¼ inch diameter. The swivel fitting 7 is a brass ¼ Mnpt×¼ Fnpt. The threaded male adapter fittings 5 are brass, ¼ Npt×¼ 1Ine. The three fluid flow sensors 18 are manufactured by Gems Sensors, and are the FS-3 series 4.10″×1×¼ inches. The cover plate 28 is 16 gauges×6×7 (long) inches. The two bolts 20 are ¼×20 (thread count)×1 inches. The studs 22 are also ¼×20 (thread count)×1 inches. The nuts 24 are ¼×20 (thread count). All of the fastening devices are made of stainless steel.

The fluid flow sensor apparatus is particularly suitable for application on wet blade bush cutting mowers, as disclosed in U.S. Pat. No. 6,164,049. A brush-cutting mower is used for clearing brush, cutting vegetation, and applying vegetation treatment fluid to cleared land, includes a mower having a convertible deck, the convertible deck having a main deck and a clam shell portion, with a clam shell portion forwardly attachable to said main deck. A distal edge of the main deck, is attachable to the clam shell portion at a radial proximal edge of the clam shell portion, the claim shell portion extends beyond the radial distal edge of the main deck. Underneath the main deck, a plurality of spindles are mounted, with one of each of a plurality of cutting blades mounted to each spindle. The mower includes a means for rotating the plurality of cutting blades, and an attachment means for selectively securing the mower to either a front end or rear end of a standard tractor. The mower includes a means for applying treatment fluid from the is lower surfaces of each cutting blade to cut brush and cut vegetation, the applying means administering treatment fluid simultaneously to the cut, open pores of vegetation as the brush and vegetation is cut. The fluid flow sensor apparatus has one fluid flow sensor for each cutting wet blade. As shown in the Figures, the invention has three fluid flow sensors, one for each of the three cutting blades. If there were four blades, then the invention would preferably have four fluid sensors. The cutting blades form a continuous blade path at least as wide as the width of the mower, with the treatment fluid applied from the lower surfaces of each of the plurality of cutting blades to the cut, open ends of vegetation. The treatment fluid is applied simultaneously from the lower surfaces of the cutting blades at the time of cutting, without application of fluid to the exterior sides of brush and vegetation, nor onto the ground, nor into surrounding air, surface water, or groundwater. The invention serves as a substantially automatic means of assuring that there is always fluid available for the wet blade. If the fluid runs low, the back pressure of the fluid line drops, and the delta pressure over the piston increases causing the piston to open and fluid to flow. The reed switch signals the controller that fluid is flowing, and flowing at a substantially known rate.

### SUMMARY OF THE ACHIEVEMENT OF THE OBJECTS OF THE INVENTION

From the foregoing, it is readily apparent that I have invented a fluid flow assembly, wherein the assembly can be quickly mounted and connected to the input and output for the fluid lines. Each fluid line connects using swivel fittings, and the fittings are present on the assembly. It is ready apparent that the assembly can be connected to the fluid lines with only a few tools. It is also apparent that the case flush fits against the transfer blocks, therein providing a protective case for all the fluid flow sensors in the case. The movement of fluid causes an electrical change, such as the opening or closing of an embedded reed switch, and this change can be detected individually, as a response to fluid movement through each of the fluid sensors. Additionally, the cover plate of the case can easily be removed my detaching (unscrewing) a couple of fastening elements, therein enabling the case to be easily inspected in the field, wherein the case has a quick removal cover. Finally, it is apparent that the assembly can be sized to handle any number of fluid flow sensors.

Thus it is apparent that there has been provided, in accordance with the invention, an apparatus that fully satisfied the objects, aims and advantages set forth above. While the invention has been described in conjunction with the specific embodiments thereof, it is evident that many alternatives, modifications, and variations will be apparent to those skilled in the art in the light of the foregoing description. Accordingly, it is intended to embrace all the alternatives, modifications and variations as fall within the spirit and broad scope of the invention.

What is claimed is:

1) A fluid flow sensor apparatus comprising: a base plate and a cover plate, said plates spaced apart by a pair of transfer blocks being mounted and held between the base plateone or more fluid flow sensor switches and the cover plate, mounted between the transfer blocks is, for measuring the presence of liquid flowing there through.

2) A fluid flow sensor apparatus as claimed in claim 1, wherein the fluid flow sensor switches produce a change in the electrical characteristics of the switch when fluid is flowing through the fluid flow sensor switches.

3) A fluid flow sensor apparatus as claimed in claim 1, wherein the transfer blocks are fitted with swivel fittings for connecting to fluid lines.

4) A fluid flow sensor apparatus as claimed in claim 2, wherein the switch on the fluid flow sensor switch is a reed switch.

5) A fluid flow sensor apparatus as claimed in claim 1, wherein the transfer blocks are sandwiched between the base plate and the cover plate

6) A fluid flow sensor apparatus as claimed in claim 1, wherein the transfer blocks are machined to a have a threaded channel for each fluid flow sensor switch, therein enabling the a fluid flow sensor having threaded connections to be facilely fluidly connected to the transfer blocks.

7) A fluid flow sensor apparatus for maintaining a substantially continuous supply of fluid to an applicator, said apparatus comprising: a base plate and a cover plate, said plates spaced apart by a pair of transfer blocks being mounted and held between the base plate and the cover plate, mounted between the transfer blocks is one or more pressure sensitive fluid flow sensor switches, for measuring the presence of liquid flowing there through.

8) A fluid flow sensor apparatus as claimed in claim 7, wherein the pressure sensitive fluid flow sensor switches open when the pressure across a pressure sensitive fluid flow sensor is sufficiently high to cause fluid to flow, therein activating an electrical switch.

9) A fluid flow sensor apparatus as claimed in claim 7, wherein the transfer blocks are fitted with swivel fittings for connecting to fluid lines.

10) A fluid flow sensor apparatus as claimed in claim 8, wherein the electrical switch on the fluid flow sensor switch is a reed switch.

11) A fluid flow sensor apparatus as claimed in claim 7, wherein the transfer blocks are sandwiched between the base plate and the cover plate

12) A fluid flow sensor apparatus as claimed in claim 7, wherein the transfer blocks are machined to a have a threaded channel for each fluid flow sensor switch, therein enabling the a fluid flow sensor having threaded connections to be facilely fluidly connected to the transfer blocks.
